(19) United States
(12) Patent Application Publication
(10) Pub. No.: US 2016/0269400 A1
(43) Pub. Date: Sep. 15, 2016

(54) Methods of Tracking and Utilizing Location Data, Biometric Data, Multibiometric Data and Other Associated Data for Computerized Communication Devices

(71) Applicant: Lawrence F. Glaser, Fairfax Station, VA (US)

(72) Inventor: Lawrence F. Glaser, Fairfax Station, VA (US)

(21) Appl. No.: 15/066,043

(22) Filed: Mar. 10, 2016

Related U.S. Application Data
(60) Provisional application No. 62/131,275, filed on Mar. 11, 2015.

(51) Int. Cl. H04L 29/06; G06Q 20/32; G06Q 20/40

(52) U.S. Cl. CPC H04L 63/0861; G06Q 20/40145; G06Q 20/3224

(57) ABSTRACT

The present invention provides enhanced security through multi-biometrics, collected from the same object where each species of biometric is correlated to the other and thereafter includes a directly associated date, time, device ID and user ID associated with the multi-biometric. The present invention emphasizes that on a user's devices we gather two or more biometrics from the same target at the same moment in time.

### BACKGROUND

In building communications and commerce systems, if we fail to incorporate appropriate technology at critical moments in time, the state of the world will get worse. The enemy becomes impossible to know from the common person. The number of people and other entities grow exponentially, and so logically, the problems associated with an exponential growth in population will demand tighter security and accountability by and between all people, in accordance with regulations and the rule of law.

20120148115, (Birdwell) while collecting a plurality of biometric data and building a relational data base, fails to gather biometrics in a manner which can be certified to have been taken at the same moment.

In like manner, 20110016317 Abe provides a plurality of encrypted templates, which may represent diverse biometrics, but adds only an encryption key stored in a non volatile memory.

U.S. Pat. No. 8,548,206 Sahin combines individual biometrics already in a data base or using a combination of instruments to measure, but lacks the device to capture two or more at the same moment, with a way to certify the data is real, with a high degree of mathematic certainty, not faked by a public enemy.

As a side bar note, it was recently in the press that a 7-year old boy hacked past a major manufacturer's finger print button/scanner. Clearly, that device and any lineage with the same security flaw, would be wholly unsuitable for most professional uses of these devices and all possible ecommerce.

The prior art fails to provide multi-biometric correlated data, correctly aligned to one another and further certified and authenticated as to whom the data was drawn from, what device, where the device was at the moment of collection and what other means exist at that moment to further certify the validity of the data.

### SUMMARY

U.S. Pat. No. 9,065,893 and U.S. Pat. No. 8,041,604 are incorporated herein by reference in their entirety for purposes of essential subject matter.

Co-pending U.S. provisional application Ser. No. 14/996,290, commonly assigned, is incorporated herein by reference in its entirety.

For purposes of this document, ‘multi-biometric’ refers to a plurality of biometric data. Also, a ‘species’ refers to an element of some set which is known and unambiguous, though the set may not in all cases be defined explicitly.

The present invention overcomes these and other problems of the prior art by providing multi-biometrics, collected from the same object where each species of biometric is correlated to the other and thereafter includes a directly associated date, time, device ID and user ID associated with the multi-biometric. The present invention emphasizes that on a user's devices we gather two or more biometrics from the same target at the same moment in time.

Apart from “electronic chipping” of people which is objectionable and impractical, the present invention aims at the next best thing. A user is treated well, and right, fairly, but in return, is tracked and up to every touch or command includes an automatic biometric transfer with additional authenticity and identifying elements as described herein.

It is an object of the present invention to certify a user's device, location, identity and the actual biometrics taken. The platform of the present invention, similar to that disclosed recently by the present inventor, in U.S. Pat. Nos. 9,065,893 and 9,122,966, can emit non-visible light-based water marks. So in essence, one reading takes 3 distinct things which may be independently and collectively analyzed. Examples would be finger print, capillary pattern and the invisible water mark. All 3 exist together, correlated, so the collected data can be matched to a prior imprint in memory and when transmitted, for further verifications, seek corroboration by other like devices nearby. (as disclosed in Ser. No. 14/996,290, which is incorporated herein by reference) So in our data base, we have certification of a lot more factors than a single biometric and automatic relation between these data. In a series of embodiments, one or more such biometrics are captured during normal touches of the screen by the user, or in ‘gesture’ cases where images of the user's finger are taken even absent physical contact, for example by Kirlean imaging. Arguably, this is potentially more than 1 trillion times more secure than relying upon only a biometric The harder the carriers, signaling, data base and hardware structure, the more difficult it would be for a public enemy to inject a false transaction, event or data of any kind into a system of this depth and security.

It is an object of the present invention to provide a way to track all electronic money in perpetuity, with a data base that includes the herein disclosed factors relating to the person who used the money and capturing other user's device data in proximity at the moment of use and transfer, to further authenticate the transaction and thwart public enemies from all forms of fraud, even capturing bad people on first attempt at fraud.

It is an object of the present invention to provide a way to track all electronic money in perpetuity, with a data base that includes the herein disclosed factors relating to the person who used the money and capturing other user's device data in proximity at the moment of use.

It is an object of the present invention to provide a data base of all activity, data mining the data base to determine preferences of the multi-biometrics and relating such things as deals, advertisements, discounts to the multibiometric match.

It is a further object of the present invention to provide a data base in a server, per terms of service of our users, to allow reviewing and reacting to the multibiometric tagging of a communication, transaction or other event, device ID, user ID, location ID and local other user IDs and their data to form up an overall probability of the event or character being real, being perfectly recorded and perfectly identified.

In yet a further object of the invention, per the terms of service of the user agreement for these devices hosting biometric and multibiometric data gathering and authentication, the user may adopt at strategy where their device gathers the data and shares solely with the server and database of this invention

The present invention further provides the improvement of modeling a finger with capillary pattern and finger print both correlated correctly to one another such that digital processing—examining the pattern in a memory to a previously stored pattern . . . the pattern alone becomes much more complex when two biometrics are taken at the same moment. The invention provides a test for “is it alive”? Use a video of it to examine the Kirlean field. (U.S. Pat. No. 9,065,893). The Kirlean field of a human finger pulses with the heart beat. Hence, the device knows the source is apparently alive. It would very difficult for wrong-doers and public enemies to falsify that high a standard for collecting a multi-biometric.

### BRIEF DESCRIPTION OF THE DRAWINGS

FIG. 1 shows the present invention.

FIG. 2 shows a use with the invention as depicted in FIG. 1.

FIG. 3 depicts a flow of control associated with use of the present invention.

FIG. 4 shows collection of biometrics/multi biometrics and preparation for network conveyance thereof

FIG. 5 shows an exemplary mobile device ideally suited to the biometric methods of the present invention.

FIG. 6 shows external details of the device of FIG. 5.

FIG. 7 shows external details of the device of FIG. 5.

### DESCRIPTION OF THE INVENTION

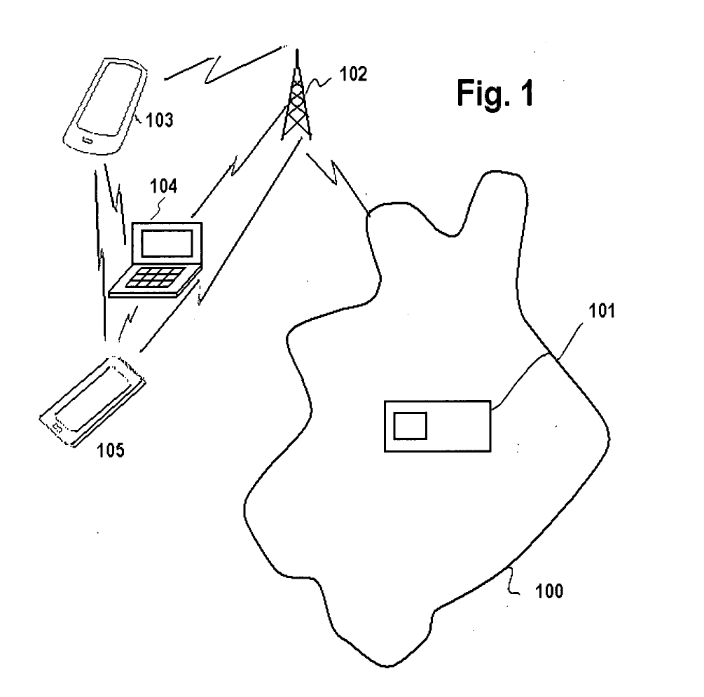

Referring to FIG. 1, depicted are elements 100 indicating a network, network cloud or the world wide web, 101 a Multi Biometric Server capable of routing information and making determinations as to what data belongs with what to append to any data passing through, 102 is a Cellular network, 103 is a MultiBiometric capable user device, 104 is another MultiBiometric capable user device 105 is yet another multibiometric capable user device.

In highly-preferred embodiments, the present invention provides automatic embedding of a biometric or multibiometric into a communication. It may be preferable to keep the embedding at the originated end, storing the association with the communication, or, alternatively, transmitted to a database and also transmitted to the receiving device.

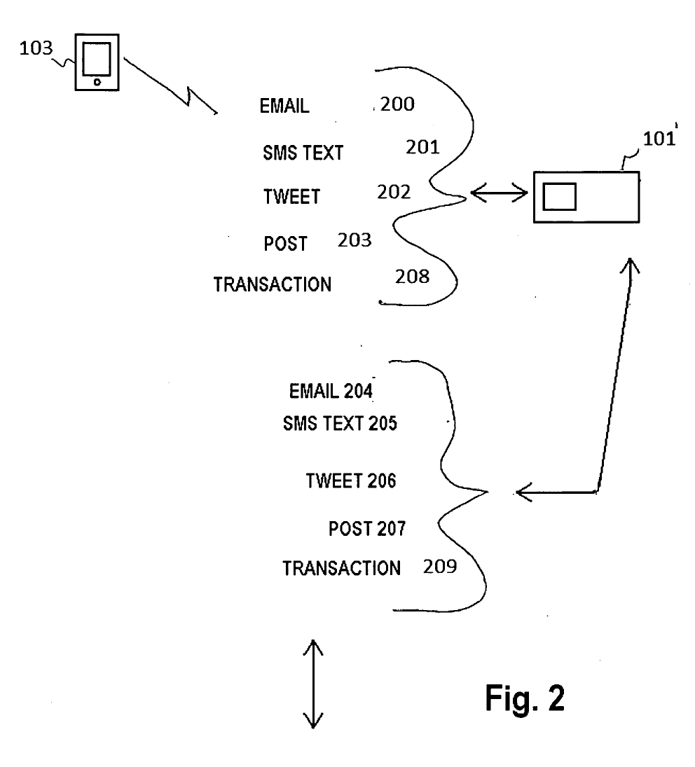

Referring to FIG. 2, species of transactions or communications to and from a multibiometric capable user device are illustrated. Elements shown are the multibiometric capable user device 103, sending or receiving multibiometric stamped communications which may include classic communications, posting or transactions such as ecommerce. The species of communication include EMAIL 200, SMS TEXT 201, TWEET 202, POST 203 and a TRANSACTION (such as ecommerce purchase) 208. These species may pass through server 101 to have information appended to them and to receive authentication. As such the species which move from the server to other devices bear a different nomenclature for clarity which includes EMAIL 204, SMS TEXT 205, TWEET 206, POST 207 and a TRANSACTION (such as ecommerce purchase) 209.

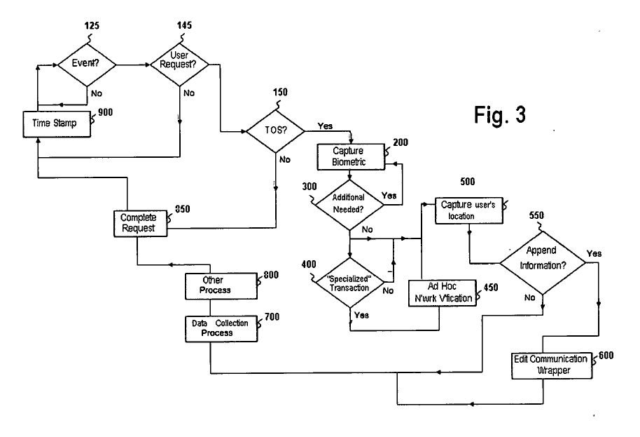

In an embodiment, since there will be a server either as a part of the network to which the device subscribes, or in another compatible network or cloud, to authenticate the biometric, at that server, we can embed or associate advertisements with the biometric (step 200) or multibiometric. (if so determined at step 300, see FIG. 3 below) This is like saying in terms of an artificially intelligent software module, the module knows who owns those finger prints and they like deals on chocolate, so along goes the best chocolate deals. By way of example, this is an automated association of the advertisement, or, alternatively, a different communication bearing the ad, as the server has enough data to make this determination and send the ad to the user if the user indicated in their settings they would like to be notified of such deals, local or otherwise. Hence, the idea, per user filters and preferences is to automatically enable advertisement inclusion into a user's communications through study of and association with their multi-biometric use patterns and transactions.

It may be preferable not to put ads inside of communications from a server, but rather, they can tag along, leading, trailing or a simple indication is sent that there are ads available for the subjects in the text portion of the message and the user can then ask for the ads, knowing they are there. An example would be an animated effect to the words “Nike Shoes” and if the message was more specific, the user wants to buy the Jordan Special Edition Nike Shoe of 2015, those words would twinkle (or provide some visual indication) and it may be preferable to have an audible indication if there was an ad available and it provided a discount. It may be preferable to have different animations and sounds indicate the amount of discount, so the user does not have to waste their time viewing the advertisement unless they want to. This way, they can know that they want to because a twinkle with a lot of blue and the sound bite XXX tells them its 50% off or more, or BOGO or more. it may be preferable for the audible to be heard when the user puts the cursor over the word that is showing there is a discount or deal available for the item in question.

Logging in and out is no longer really necessary, though it may preferably be maintained as a legacy expectancy. If someone else touches a given user's device directly or with a gloved hand, these devices can detect this event and shut down while not providing any data or response.

Referring to FIG. 3, steps 125 and 145 provide looping event handlers to be constantly aware of user activity. In addition, through the cross communications suggested for these devices, such as through available local proximity limited networks, a local CCTV and DVR may preferably, as determined at step 400, be instantly alerted to take closer images, as shown in step 450.

In an embodiment, the present invention provides marking all communications with the multibiometrics, including, by way of non-limiting example a directly associated date, time, (step 900) device ID and user ID associated with the multi-biometric.

In embodiments, the present invention sends (at step 800) ads based on the multi-biometric identity. Structurally, multibiometrics are useless without something in between to authenticate them. So during the authentication process, if the user so selects, the application can get advertisements available to the owner of the multibiometrics involved and with proper flow control, between two or more parties, the server would know which way to send which ad. By way of example, the server is queried to authenticate a transaction between 3 parties. All 3 may get some pertinent ads (pertinent to them, per their own settings and filters) if they have their settings allowing such ads. 8041604 used the user and their requirement to log in, to then know who was who. The present invention eliminates the need for logging. The CARD and SURFACE gets, at step 200, the multibiometric for up to every move the user makes, every command, so when the server is queried to authenticate, that is where ads could be associated with the biometric, based on a large data mine built up over time. For the purpose of ad distribution the server does not know or care about identity to make its selection, it only needs to know preferences for that biometric. It can only act on the unique identification of the biometric data and determine the thumb print and capillary print just received when analyzed matches file XXXYYYZZZ. As such, the communications which flow through this server bearing this multi-biometric, mention chocolate as a like for id XXXTTTZZZ hence the server can make the association successfully without knowing the ID of the User.

In an embodiment of the invention, each possible communication will bear at least one multibiometric, therein, the server has information upon which it can act to append the information stream, at step 550, which may include insertion or extraction, at step 600, of any least common denominator element up to and including the entire communication string being replaces or greatly appended in any manner necessary to deliver such features as authentication, advertisement insertion with sensitivity to the data stream elements, compilation of certainty of the User's identity, device ID and location, captured at step 500 including additional data collection as needed at step 700.

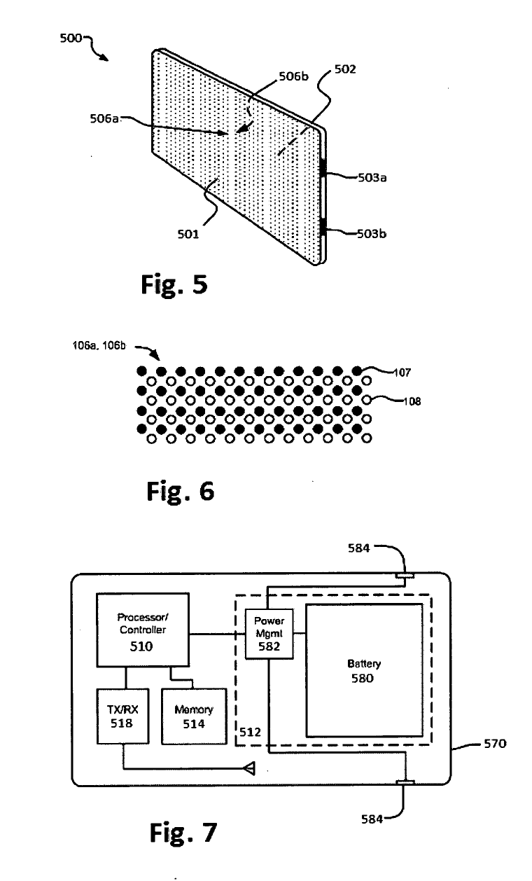

In an embodiment, the surface of U.S. Pat. Nos. 9,122,966 and 9,065,893, as shown more clearly below in FIGS. 5-7, captures a biometric and multi biometrics for every touch and for gestures performed by the user. As such, if the user is operating an app which controls a CGI (Computer graphic Image) such as a character in a game, the biometrics and multi biometrics are known to the server supporting the application. Therein, with user agreement 150 per TOS (Terms of Service) they may advertise their favorite products through their CGI character, automatically. As such, the CGI character could resemble, for example, a NASCAR race car and just like the auto racing industry, advertising becomes meaningful and important. Say a great gamer with high gaming scores uses an off brand of game controller called YYZZ. By advertising YYZZ in a designated area of their CGI character, the user gets credits or points for every YYZZ purchased as a result of their ad. Ads could appear on the CGI character scaled and contoured, or on an object related to the CGI character, such as their CGI gun or CGI clothing.

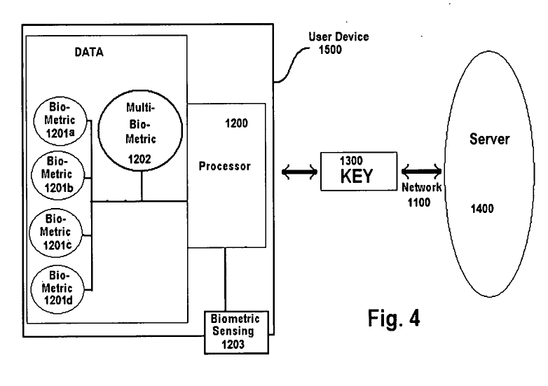

Referring to FIG. 4, the present invention provides a server with more certain authentication features than any other server or software available today. To make the system, more certain of the things it will authenticate, this invention provides location data, device ID and Biometrics 1201a-d (or multibiometrics 1202, consisting of a plurality of these biometrics) to the server. Although the drawing depicts, by way of example, 4 different possible biometrics, the actual number may be lower or higher. Then, the server 1400 has a unique way of reaching out to the source of these data to check to see if its something the server can authenticate with more certainty. So the server sends a key 1300 to each device 1500 associated with the request to authenticate information from the device. Since the server will receive more than one authentication request bearing the device'ID, or the User's biometrics, the server can send keys down other pathways. All local devices exchange keys using a local network. Networks 1100 such as Wi Fi, Blue Tooth will suffice. As discussed above, various methods are contemplated, in the context of the present invention, to prepare and collect biometrics. These various methods of collecting, otherwise referred to as ‘sensing’, are broadly depicted in FIG. 4 as sensor. (element 1203)

So what the server sees back next is confirmation from each device with keys included that were sent to other local devices. This confirms the other local devices are in proximity to the first device due to the nature of the networks used to exchange keys. eg Wi Fi and Blue Tooth are very local, limited range. One last thing that adds some depth, the local Wifi routers can serve as devices for this purpose. So, a user can be in Target, do a transaction and the WiFi router nearest the user helps to transpond with the server of this invention. When that WiFi router was first placed into service, it can have a calibration mode which goes out to the server of this invention and provides technician data that certifies the location data. lat Long, GPS provided data and any other location related data. When the server of this invention communicates with routers all over the US and world, these act as safety nets to provide the crossing of the keys to assure, the device really is close to the Wi Fi Router.

Referring to FIG. 5, in a major embodiment of the invention, is shown mobile device in card form-factor 500 having surface 501 and optional second surface 502 as well as, by way of example, first physical port 503a and second physical port 503b.

Attributes, especially suited for collection of biometrics, of card form-factor mobile device 500 are further shown in FIG. 6, including intermixed array 506a composed of light emitting pixels 507, light emitting elements 508.

Makeup of card form-factor mobile device 500 is further exemplified in FIG. 7, including substrate 570, processor 510; power supply 512 including a battery 580, such as a thin/ultrathin film lithium ion or lithium polymer battery, a power management device 582; memory 514; communication unit 518, and charging electrodes 584.

The device of the present invention provides substantial new and useful capabilities for the power of multimedia. It is now possible to verify whether and how a given user has viewed a video, graphic, hypertext or other expanded form of content. For example, in the case of a response to a large-scale crises such as may be created by terrorism, law enforcement and first responders, being equipped with the technology disclosed herein, may be sent tutorials or other info packages. The present invention allows real-time monitoring or after-the-fact reviewing to see who actually took the time to absorb the info packages, and what benefits these packages provided, among other monitoring data. In accordance with the invention, it is possible to know not only whether a person chose to study a certain such info package, but also how and whether they took time to absorb a certain segment by repeated viewing. Such viewership data may indicate things such as, not only a person's enthusiasm for their job, but also their level of aptitude in acquiring new information in a crisis environment, and whether they are suited for the task.

Since the foregoing example explains benefits in situations where life and limb may be at stake, it should be fairly straightforward for a person having skill in the art to envision a multitude of other uses. In business, for example: legal or insurance contracts may now be presented in multimedia form. Persons entering into a contract may with certainty be said to have read and understood the terms beforehand, without the need to halt all user activity until such a person has clicked an “I agree” type button, as is typically the case in the prior art, when a user assumes liability.

In addition to the foregoing benefits for consumption of media, the present invention also provides benefits from the point of view of media production. For example, any video made for criminal purposes, such as in the event of a kidnapping, if made with a device equipped with the new technology of the present invention, provides a clear digital trail back to the perpetrators. Even in the case where such a video is not originally made with a device of the present invention, benefits may result from this device, for example in the case where, among early viewers of such a video (posted, by way of, example on a website) may be someone who is inadvertently indicating advance knowledge of the crime, which would be incriminating. Likewise, in the case of amateur or accidental CCTV crime video posted online, early or obsessive viewing may indicate some involvement.

If a user set their multibiometrics or biometrics server profile to carbon copy messages to multiple forms of communications, the text part or pictures, videos could be resent but there will be header and footer data that differs per communications species. Examples would be Email versus SMS Text versus Tweet. They are wildly different, but, if it's just a text message or text message with a pic, that portion remains the same. We could also want to reduce the pixels in the pic (compress it) to meet guidelines, such as SMS Tex requiring less pixels or it will block the pic. Or to comply with user settings for transfer speeds, wherein, 20 mega pixel images are reduced to 4 megapixels, per user request, to speed up transfer rates.

In any given data stream, there are logical reasons to remove some of the initial inbound information. And also to append data to the outbound side.

It is an object of the present invention to provide a way to track all electronic money in perpetuity, with a data base that includes the herein disclosed factors relating to the person who used the money and capturing other user's device data in proximity at the moment of use and transfer, to further authenticate the transaction and thwart public enemies from all forms of fraud, even capturing bad people on first attempt at fraud. It is an object of the present invention to build a database of all information coming from and going to any recipient wherein any and all data is stored and related such that, through filters, the user may guide the system to provide or not provide information of any form which the relational data suggests the user may benefit from. Equally, the server and database can also allow the user settings and preferences, as well as filters, to block, re-rout or carbon copy information passed to the user or a single piece of information can be sent to multiple users per their settings, filters and preferences set in this server and data base. For these purposes, an application may be developed which allows the user to first establish a session with their own device using their multi-biometric id, thereafter, once past security, they may update their preferences, filters, blocking, carbon copying locally, in their own device, or, directly modify the preferences in the central database and server. This application would need to synchronize the central server and its stored database with the local preferences of the device, if the device has the internal capacity to remember and apply the preferences. The value of having the device mirror the database and server with these functions is to cut down on communications leaving the device to the server, if for example, there is a block or filter applied and nothing in a given event or communications (or a given transaction) is intended to pass onward to the central data base.

In yet a further embodiment of the present invention is the idea of a data base in a server, per terms of service of our users, to allow reviewing and reacting to the multibiometric tagging of a communication, transaction or other event, device ID, user ID, location ID and local other user IDs and their data to firm up an overall probability of the event or character being real, being perfectly recorded and perfectly identified. The associated data base may include up to every event such as turn device on, make or receive a communications, up to every keystroke, up to every use of every application (application being typically small compatible operable programs provided by other third parties). Mining this data base would be enviable and of great benefit to the modern network-enabled marketplace and social services arena as well as financial services. For example, through this data mine, one could determine what advertisement is best suited to present to a user, when and how, to get the best reaction from the user and win the user's confidence that the ad is not taken as spam, rather, was meaningful and of value due to its appropriateness and timing. Through use of this data base and allowing a user to find their associated historic biometric relational data, even with the data masked from view, the user can set settings to do such things as forward or copy messages, build filters to block incoming information, build a profile to filter out ads and offers so as to assure only the suitable offers ever appear and in appropriate time so the user of a given device can act upon the information.

Per the terms of service of the user agreement for these devices hosting biometric and multibiometric data gathering and authentication, the user may adopt a strategy where their device exclusively gathers such data as location, biometric, multibiometric, and any other form of data available to the device and shares solely with the server and database of this invention, wherein, any and all third party searches e.g. Google, AOL Search, YAHOO Search, BING, Ask and all search functions, must address the server directly and go through the central data base. This serves to protect the user's data as one database and server (or a virtual server) which is easier to protect and harden, rather than trust to the thousands of various avenues that may be hacked or otherwise compromised. Most of all, the user can decide per preference settings, filters, blocks and any other variable we can offer to the user logical or relational, which service or carrier is worthy of having access to such data as their device id, location, correlated biometric data, multi biometric data, any combination of any data stored by or emitted by their device. If the central server, database and services of this invention provide more demonstrated protection and value to the user, for the first time this inventor has seen, the user, the owner of the biometric and multibiometric gets to decide knowingly, with whom or what they will or will not share these data and what is in it for them in return for their patronage. The sharing with search engines and other providers will be dependent upon the settings these users desire. They can range from no share to conditional sharing wherein they get something for their willingness to share each and every data species and to what depth. Clearly, to administer such a system, there needs to be a device capable of doing the data collection, preferably wholly automated as the devices of these invention series are, then a central repository for the data, a powerful server or virtual server to serve the user base and the venue owner base, financial industry base and all other potential users or organizations, and lastly, to serve the delimited access to search functions with benefits for the user as described herein. e.g. If a search service such as “TOOGLE” wants to know my current location, tell me what I get for revealing it? What's in it for me? Also, give me proof after I agree, that I am getting what I was promised. A report I can see on the internet or a network and then audit my activities to know I am truly getting what was promised. I already have the main service which protects my data and assures police, fire, emergency services can be directed to me, for my protection, or a panic feature can do the same, why do I need TOOGLE to know my location? Compel me, otherwise no deal. The idea is to automate the concept of data share for any and all data species, transaction data, communications and any data associated with my communications either the actual communications or attachments as communications access to and from the user to benefit the user and not to denude the user of the value of their own data and communications, both real time and historic. A great deal of the value in data mining presides within the history of a given user, or, patterns associated with specific biometrics and multibiometrics so as to provide value in return for access.

Biometrics and Multi-Biometrics as defined in this specification are searchable patterns. Per the terms of service of the end user agreement, users may elect to protect their data from user ID, account ID, device ID, to their own biometrics or biometrics of others using the device. Other data is available such as communications information, attachments to communications, commerce transactions, picture taking, videos, programs owned by the user, essentially any data which can be associated with the user is equally addressed by this invention. Per the terms of service of the end user agreement, the user can selectively share or not share any data and any association, with select or all search engines of the world

Those experienced in the field of this invention should, based on the detailed descriptions of the objectives and new methods, be able to understand the logical possible variations. They will be able to adopt appropriate strategies depending on the various applications and needs of video, RFID and smartphone devices, not specifically shown in this application, but within the general goals and objectives of this invention.

Examples disclosed are intended to be limiting only as reflected in the appended claims.

1. A system for authenticating comprising
a mobile device comprising a microprocessor and a mixed array sensing and displaying surface and a wireless communication transceiver, the microprocessor programmed to:
sense, using the sensing and displaying surface, a biometric characteristic from an object adjacent the sensing and displaying surface to generate biometric data pertaining to a user
a server comprising a CPU, a clock and a wireless communication transceiver, the CPU programmed to:
compare the generated data to stored biometric data; and
determine whether to accept the user based on the comparison.

2. The system of claim 1 wherein said microprocessor is further programmed to substantially simultaneously capture a first biometric and a second biometric related to said first biometric, for a substantial portion of actions taken by a user of said mobile device.

3. The system of claim 2 wherein said microprocessor is further programmed to mark a communication which said device originates or terminates with said first and second biometric characteristics.

4. The system of claim 3 wherein said communication is selected from the list including a voice call, email, text, tweet, post to a web page, photo, video, use of a service, use of a video game, ecommerce transaction or perusal of an object equipped for internet of things capability.

5. The system of claim 4 wherein said ecommerce transaction comprises a step of including a biometric or multibiometric recording relating to each least common denominator of currency bearing a unique identifier involved in said transaction.

6. The system of claim 2, further comprising, in a server, relating a unique identifier associated with the device, the unique identity of the user, the biometric and multibiometric library relating to the unique user, the user's location at the moment of each transaction, other users in proximity to the user and their data correlating back to the transaction based on time and proximity to said user.

7. The system of claim 6, further comprising steps of
compiling a database of a portion of all user activity
data-mining the database to determine preferences of the multi-biometrics and relating informational messages intended for the user to said unique identifier.

8. The system of claim 2 wherein said mobile device further comprises first- and second-sided substrate having a multilayer stack of pixels perpendicularly-disposed thereon,
at least one pixel on said first side produces an output,
at least one input passing entirely through said stack,
wherein the improvement comprises
at least two biometrics collected from said input, wherein said two biometrics are correlated together.

9. The system of claim 8 wherein said correlation includes digital information directly associated with said two biometrics, said information selected from the list of date, time, a device ID and a user ID.

10. A computer-implemented method of authentication using a communication device including a major surface including a display and a mixed array including at least two different arrayed pixels, each said mixed array occupying area of the respective communication device coinciding, in plan view perpendicular to the major surfaces, with at least substantially the entire major surface, the method comprising: sensing, using the at least two different arrayed pixels, at least two types of biometric characteristics from an object adjacent the major surface to generate biometric data related to the two characteristic types; comparing the generated data to stored biometric data; and determining whether to authenticate based on the comparison.

11. The computer-implemented method of claim 10 further comprising a step of substantially simultaneously capturing a first biometric and a second biometric related to said first biometric, for a substantial portion of actions taken by a user of said mobile device.

12. The computer-implemented method of claim 11 further comprising a step of marking any communication which said device originates or terminates with said first and second biometric characteristics.

13. The computer-implemented method of claim 12 wherein said communication is selected from the list including a voice call, email, text, tweet, post to a web page, photo, video, use of a service, use of a video game, ecommerce transaction or perusal of an object equipped for internet of things capability.

14. The computer-implemented method of claim 13 wherein said ecommerce transaction comprises a step of including a biometric or multibiometric recording relating to each least common denominator of currency bearing a unique identifier involved in said transaction.

15. The computer-implemented method of claim 14 further comprising, in a server, relating a unique identifier associated with the device, the unique identity of the user, the biometric and multibiometric library relating to the unique user, the user's location at the moment of each transaction, other users in proximity to the user and their data correlating back to the transaction based on time and proximity to said user.

16. The computer-implemented method of claim 15 further comprising steps of
compiling a data base of at least a portion of all user activity
data-mining the data base to determine preferences of the multi-biometrics and relating such things as deals, advertisements, discounts to the multibiometric match.

17. The computer-implemented method of claim 9 wherein said mobile device further comprises first- and second-sided substrate having a multilayer stack of pixels perpendicularly-disposed thereon,
at least one pixel on said first side produces an output,
at least one input passing entirely through said stack,
wherein the improvement comprises
at least two biometrics collected from said input, wherein said two biometrics are correlated together.

18. The computer-implemented method of claim 17 wherein said correlation includes digital information directly associated with said two biometrics, said information selected from the list of date, time, a device ID and a user ID.

19. The system of claim 2 wherein said mobile device further comprises a credit card “form-factor” computing device having a primary side and a secondary side,
a substrate, imaging means, display means, a processor, memory and at least one magnetic region wherein;
said processor is connected to said imaging means, said display means,
said memory and said at least one magnetic region;
said imaging means comprises a collection of light-receiving pixels disposed in substantially uniform density throughout at least a major area of the primary side,
said display means comprises a collection of light-emitting pixels disposed in substantially uniform density throughout at least a major area of at least said primary side;
said magnetic region is disposed on the card so as to make contact with a standard “POS” swiping apparatus and is adapted to interact magnetically with said swiping apparatus and wherein
said collection of light-receiving pixels is adapted to form an image taken from substantially the planar region of space proximate said collection of light-emitting pixels and
said collection of light-emitting pixels is of sufficient density to display substantive information;
wherein the improvement comprises
a biometric collected from said collection of light-receiving pixels.
